(19) United States
(12) Patent Application Publication
(10) Pub. No.: US 2005/0215159 A1
(43) Pub. Date: Sep. 29, 2005

(54) Aging method of plasma display panel

(76) Inventors: Masaaki Yamauchi, Osaka (JP); Takashi Aoki, Osaka (JP); Akihiro Matsuda, Osaka (JP); Koji Akiyama, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/510,984

(22) PCT Filed: Feb. 16, 2004
(86) PCT No.: PCT/JP04/01651

§ 371 Date: Oct. 13, 2004

(30) Foreign Application Priority Data
Feb. 19, 2003 (JP) 2003-041125

(51) Int. Cl. H01J 9/46; H01J 9/44

(52) U.S. Cl. 445/6; 445/62

(57) ABSTRACT

In the aging process performed by applying a voltage having an alternate voltage component between a scan electrode and a sustain electrode, an erase discharge occurs in succession to an aging discharge. According to the aging method of the present invention, an erase discharge-suppressing voltage is applied to at least any one of the scan electrode, the sustain electrode, and the data electrode. Although the erase discharge repeatedly occurs in the wake of the aging discharge, the erase discharge-suppressing voltage suppresses the ones that occur when the scan electrode takes voltage level higher than the sustain electrode.

### TECHNICAL FIELD

The present invention relates to a method of aging an alternative current (AC) plasma display panel.

### BACKGROUND ART

A plasma display panel (hereinafter referred to as a PDP or simply a panel) is a display device with an excellent visibility, large screen, and low-profile, lightweight body. The difference in discharging divides PDPs into two types of the alternative current (AC) type and the direct current (DC) type. In terms of the structure of electrodes, the PDPs fall into the 3-electrode surface discharge type and the opposing dscharge type. In recent years, the dominating PDP is the AC type 3-electrode surface discharge PDP by virtue of having higher resolution and easier fabrication.

Generally, the AC type 3-electrode surface discharge PDP contains a front substrate and a back substrate oppositely disposed with each other, and a plurality of discharge cells therebetween. On a front glass plate of the front substrate, scan electrodes and sustain electrodes as display electrodes are arranged in parallel with each other, and over which, a dielectric layer and a protecting layer are formed to cover the display electrodes. On the other hand, on a back glass plate of the back substrate, data electrodes are disposed in a parallel arrangement, and over which, a dielectric layer is formed to cover the electrodes. On the dielectric layer between the data electrodes, a plurality of barrier ribs is formed in parallel with the rows of the data electrodes. Furthermore, phosphor layer is formed between the barrier ribs and on the surface of the dielectric layer. The front substrate and the rear substrate are sealed with each other so that the display electrodes are orthogonal to the data electrodes in the narrow space between the two substrates. The narrow space, i.e., the discharge space is filled with discharge gas. The panel is thus fabricated.

Such a panel just finished, however, generally exhibits a high voltage at the start of discharging, and the discharge itself is in an unstable condition. The panel is therefore aged in the manufacturing process to obtain consistent and stable discharge characteristics.

Conventionally, a method—in which an anti-phased rectangular wave, that is, voltage having an alternate voltage component is placed between the display electrodes, i.e., a scan electrode and a sustain electrode for a long period of time—has been employed for aging panels. To shorten the aging time, some methods have been suggested. For example, Japanese Patent Non-Examined Publication No. H07-226162 introduces the method in which a rectangular wave is applied, via an inductor, to the electrodes of a panel. On the other hand, Japanese Patent Non-Examined Publication No. 2002-231141 suggests the method as a combination of two kinds of discharging. According to the method, pulse voltage having different polarity is placed between a scan electrode and a sustain electrode (i.e., discharging in the same surface) and consecutively, pulse voltage having different polarity is now placed between the display electrodes and the data electrodes (i.e., discharging between the opposite surfaces).

Even employing the methods above, the aging time still takes about 10 hours before obtaining a stabilized discharging. The long aging time inevitably increases power consumption in the aging process, which has been a leading cause of increasing the running cost of manufacturing PDPs. Besides, the time-consuming aging process has caused problems: the factory space for keeping the panels for the aging process, and environmental conditions, such as air-conditioning, for properly maintaining the panels through the manufacturing process. From now on, further increase in manufacturing volumes and screen-sizes of the PDP apparently encourages the problems above and invites serious conditions.

The present invention addresses the problem above. It is therefore an object of the invention to provide an improved method of aging panels, allowing the aging time to be significantly reduced with an efficient use of electric power.

### DISCLOSURE OF THE INVENTION

According to the method of aging PDPs of the present invention, in the aging process where a voltage having an alternative voltage component is placed at least between a scan electrode and a sustain electrode to perform aging discharge, a voltage is applied to at least one of the scan electrode, sustain electrode, and data electrode so as to suppress an erase discharge that occurs in the wake of the aging discharge.

### BRIEF DESCRIPTION OF THE DRAWINGS

FIG. 1 is an exploded perspective view illustrating the structure of a panel to be performed aging of an exemplary embodiment of the present invention.

FIG. 2 shows the arrangement of electrodes of the panel.

FIG. 3 shows a waveform of voltage applied to an electrode in the aging method of a first exemplary embodiment.

FIG. 4 shows a waveform of voltage applied to an electrode in a conventional aging method, a voltage waveform at an electrode terminal section, and light-emission waveform of a panel.

FIG. 5 shows a waveform of voltage applied to an electrode in the aging method of a second embodiment.

FIG. 6 illustrates the generating mechanism of an erase discharge.

FIG. 7 shows a waveform of voltage applied to an electrode in the aging method of a third embodiment.

FIG. 8 is a block diagram showing the structure of an aging device for aging panels according to the aging methods described in the first through third embodiments.

FIG. 9A shows the appearance of voltage waveform setting unit of a device for aging panels according to the aging methods described in the first through third embodiments.

FIG. 9B illustrates the setting values to be defined in the voltage waveform setting unit by showing a waveform of voltage applied to each electrode according to the third embodiment.

FIG. 10 shows the aging time shortened by the aging method of the third embodiment in comparison with the time required in a conventional aging method.

### DETAILED DESCRIPTION OF CARRYING OUT OF THE INVENTION

The exemplary embodiments of the present invention are described hereinafter with reference to the accompanying drawings.

First Exemplary Embodiment

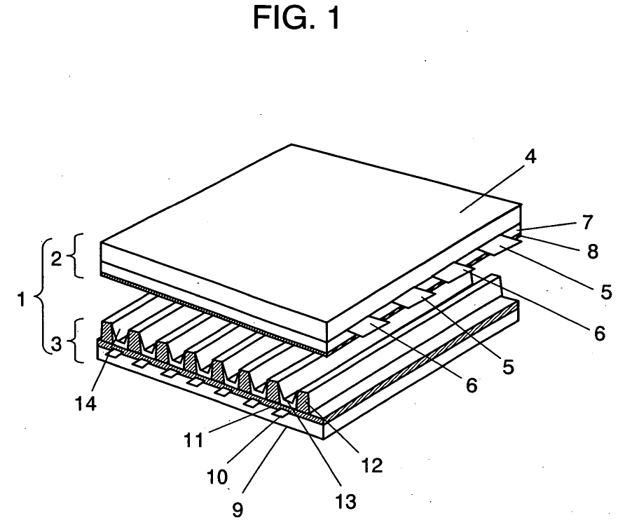

FIG. 1 is an exploded perspective view illustrating the structure of a panel to be performed aging of an exemplary embodiment of the present invention. Panel 1 contains front substrate 2 and back substrate 3 in a confronting arrangement. On front glass plate 4 of front substrate 2, a plurality of pairs of scan electrodes 5 and sustain electrodes 6 is arranged in parallel. The array of scan electrodes 5 and sustain electrodes 6 are covered with dielectric layer 7, and over which, protecting layer 8 is formed to cover dielectric layer 7. On the other hand, on back glass plate 9 of back substrate 3, a plurality of data electrodes 10 is disposed in a parallel arrangement, and over which, dielectric layer 11 is formed to cover electrodes 10. On dielectric layer 11, a plurality of barrier ribs 12 is formed in parallel with the rows of data electrodes 10. Furthermore, phosphor layer 13 is formed between barrier ribs 12 and on the surface of dielectric layer 11. Discharge space 14 between front substrate 2 and back substrate 3 are filled with discharge gas.

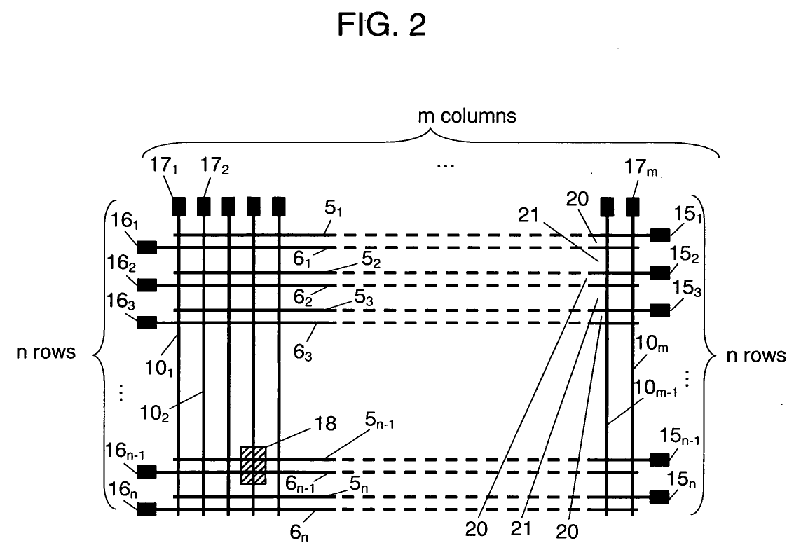

FIG. 2 shows the arrangement of electrodes of panel 1 of the embodiment. m data electrodes 10₁-10ₘ (corresponding to data electrodes 10 shown in FIG. 1) are arranged in a direction of rows. On the other hand, in a direction of columns, n scan electrodes 5₁-5ₙ (scan electrodes 5 of FIG. 1) and n sustain electrodes 6₁-6ₙ (sustain electrodes 6 of FIG. 1) are alternately disposed. The array of the electrodes above forms m×n discharge cells 18 in the discharge space. Each of cells 18 contains a pair of scan electrode 5ᵢ and sustain electrode 6ᵢ (i takes 1 to n) and one data electrode 10ⱼ (j takes 1 to m). Scan electrode 5ᵢ is connected to corresponding electrode terminal section 15ᵢ disposed around the perimeter of the panel. Similarly, sustain electrode 6ᵢ is connected to sustain electrode terminal section 16ᵢ; and data electrode 10ⱼ is connected to data electrode terminal section 17ⱼ. Here, the gap formed between scan electrode 5 and sustain electrode 6 for each of cells 18 is referred to as discharge gap 20, and the gap formed between the discharge cells, i.e., between scan electrode 5ᵢ and sustain electrode 6ᵢ₋₁ that belongs to the next discharge cell is referred to as adjacent gap 21.

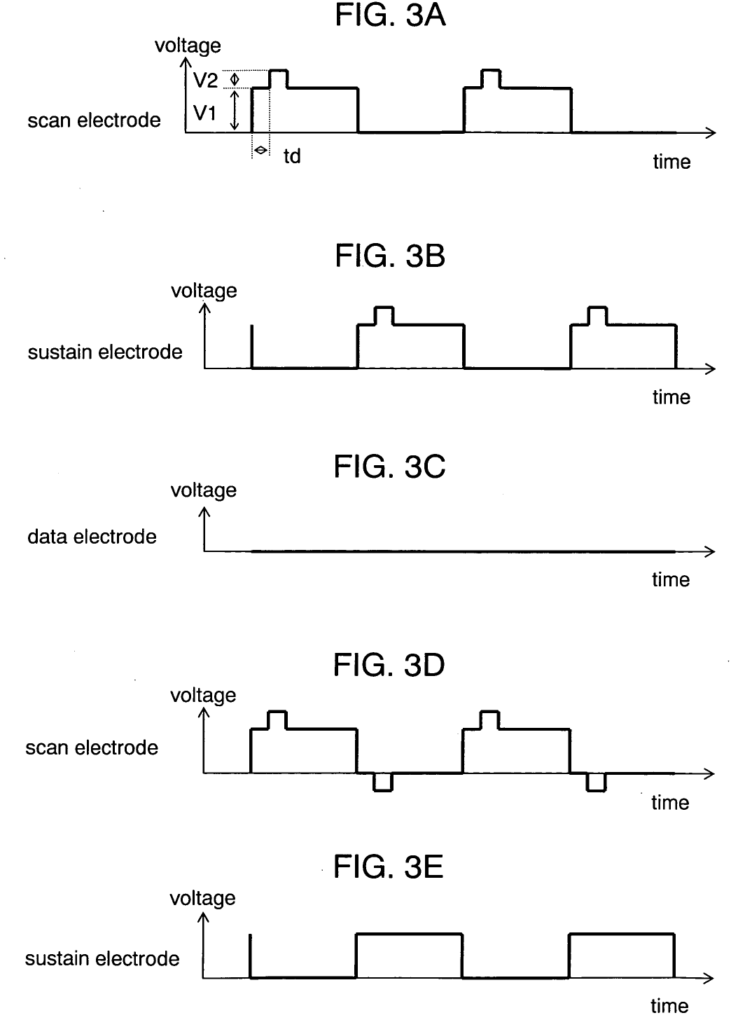

FIG. 3 shows a waveform of voltage applied to an electrode in the aging method of the embodiment. Specifically, FIGS. 3A, 3B, and 3C show a voltage waveform for scan electrode 5, sustain electrode 6, and data electrode 10, respectively. According to the aging method of the embodiment, as is apparent from the figures, the waveform of voltage applied to scan electrode 5 and sustain electrode 6 does not exhibit a simple series of rectangular form; it shows another small rise with a delayed time of td after the rising edge of voltage. The result of the experiment—where, each value of FIG. 3 is set as follows: V1=200V, V2=100V, td=3 μs, (the pulse-repetition period is constantly defined to 25 μs)-showed that the aging time was cut in half that of a conventional method.

It will be understood that the optimal values of voltage V1, V2 and time distance td depend on the shape and dimensions of the electrodes, the material of a panel, inductance of an aging circuit. Therefore, the setting values have to be changed for a differently designed panel.

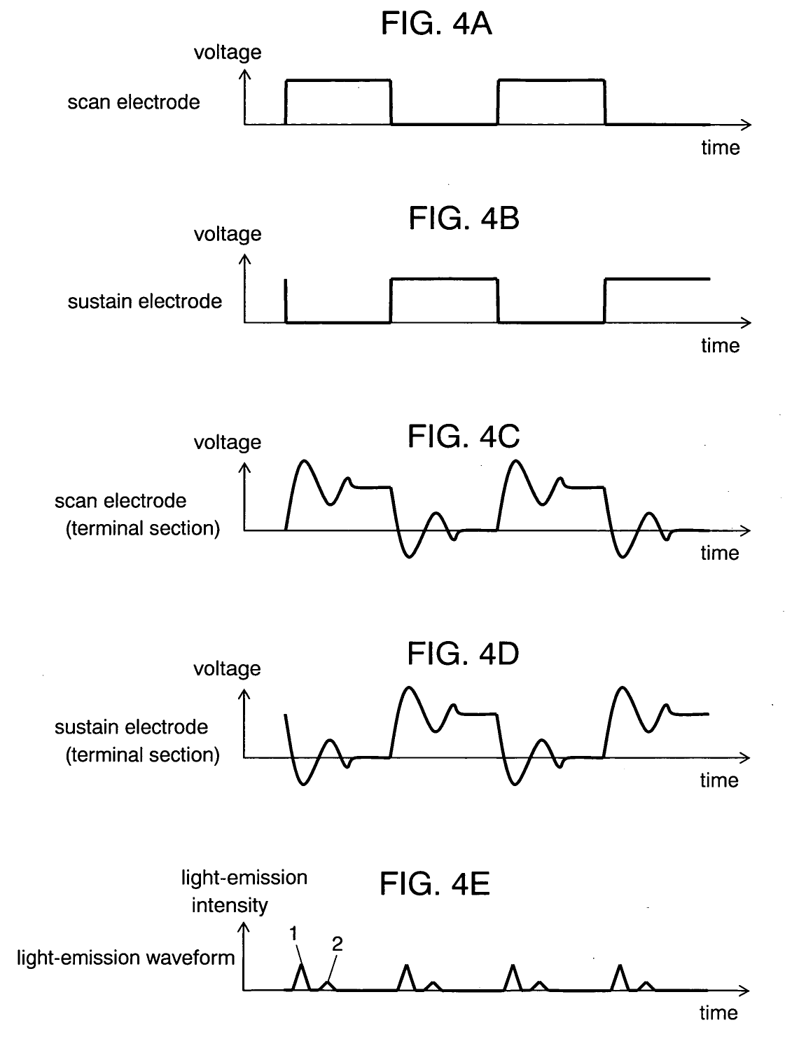

Now will be described the reason why the aging method of the embodiment can shorten the aging time. FIGS. 4A and 4B show waveforms of voltage applied to scan electrode 5 and sustain electrode 6, respectively, in a conventional aging method. At this time, scan electrode terminal section 15 and sustain electrode terminal section 16 exhibit respective voltage waveform, which are schematically shown in FIGS. 4C and 4D. As shown in the figures, in spite of the fact that the voltage waveform generated is rectangular in shape, ringing is superimposed on the rectangular shape of each waveform at terminal sections 15 and 16. Although the phenomenon is unavoidable in an aging circuit incorporating an inductor, even in a circuit with no inductor, it also occurs from resonance of floating inductance and capacity of a panel. That is, the ringing is inevitably superimposed on the voltage waveform at the electrode terminal section.

FIG. 4E schematically shows light emission of a panel as a light-emission waveform detected with a photo sensor. Each crest of the waveform shows the moment at which the discharge occurs. In FIG. 4E, minor discharge (2) following major discharge (1), which occurs in the wake of overshoot, is an erase discharge that erases wall charge. The erase discharge has little aging effect in spite of consuming electric power. Besides, due to the weakened wall discharge, a large voltage is required to generate the following discharge, resulting in reduced efficiency of aging. Furthermore, the magnitude of the erase discharge depends on the characteristics of each discharge cell; the aging time takes longer for the cell that is likely to have erase discharge. To perform the aging process satisfactorily for all the discharge cells, further longer aging time is required.

According to the aging method of the first embodiment, in order to suppress the erase discharge that follows the aging discharge, a voltage is applied to scan electrodes 5 and sustain electrodes 6 at the exact moment when the erase discharge occurs. As a result, an efficient aging can be obtained. The detection of the light emission of the panel by a photo-sensor proved that light emission in the wake of the erase discharge weakened.

Although the waveform of voltage applied to both of scan electrodes 5 and sustain electrodes 6 has another small rise with a delayed time of td after the pulse rising time, as shown in FIGS. 3A and 3B, it is not limited thereto. A voltage having a rectangular waveform may be applied to sustain electrodes 6, and the aforementioned erase-discharge suppressing voltage may be applied to scan electrodes 5 just after the rise and the fall of the waveform, as shown in FIGS. 3D and 3E, or vice versa (not shown)—the rectangular waveform voltage may be applied to scan electrodes 5, and the erase-discharge suppressing voltage may be applied to sustain electrodes 6.

Second Exemplary Embodiment

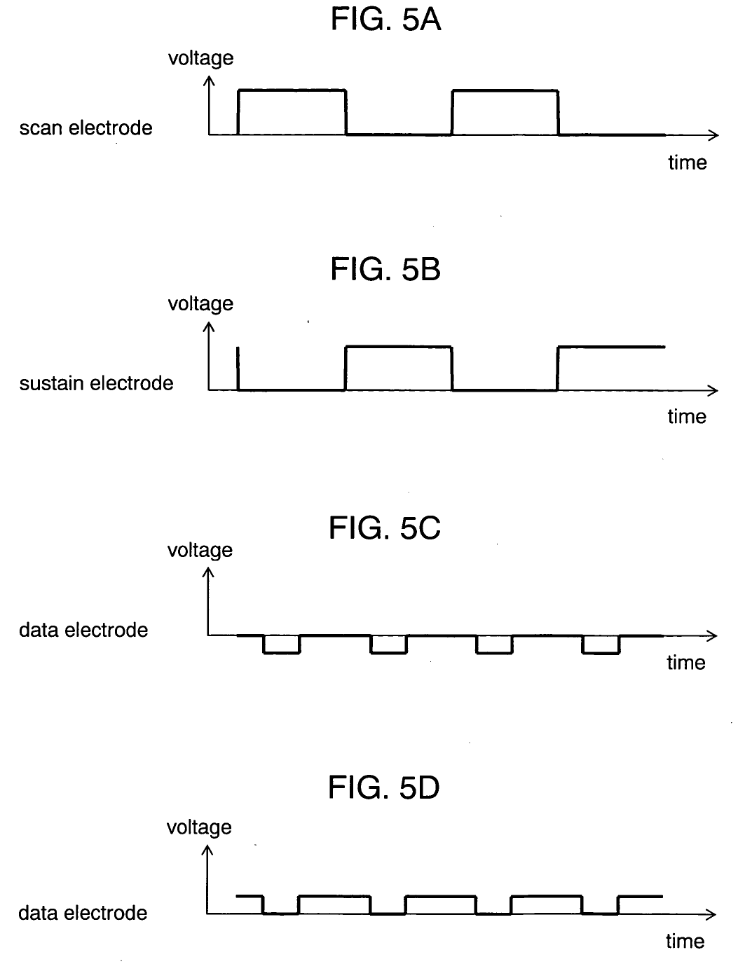

FIG. 5 shows a waveform of voltage applied to an electrode in the aging method of a second embodiment. FIGS. 5A and 5B show the waveforms of voltage applied to scan electrodes 5 and sustain electrodes 6, respectively. The voltage applied to electrodes 5 and 6 is a simple rectangular pulse train having alternate voltage component. FIG. 5C shows the waveform of voltage applied to data electrodes 10. The aging method of the embodiment differs from the method of the first embodiment in that the erase discharge-suppressing voltage is applied to data electrodes 10, instead of scan electrodes 5 and sustain electrodes 6. Because data electrodes 10 don't carry a large discharge current, the method of the embodiment allows the data electrode-driving circuit to have a small power consumption and a simple structure.

Now will be described the reason why the application of voltage to data electrodes 10 can suppress the erase discharge.

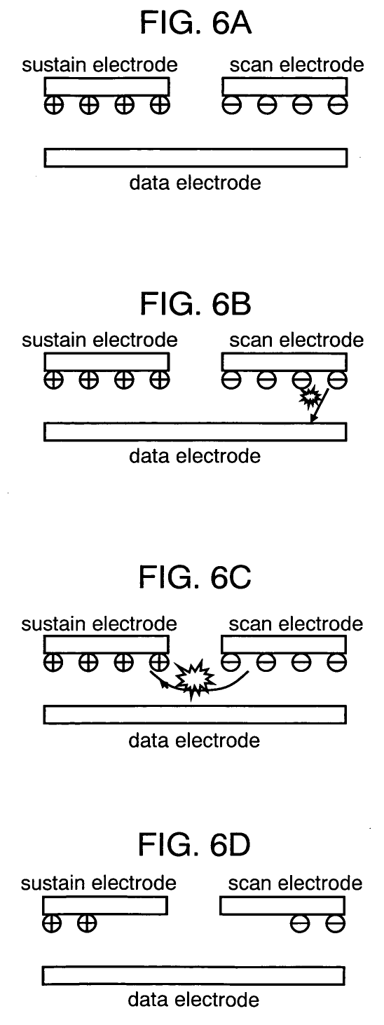

FIGS. 6A through 6D illustrate the generating mechanism of an erase discharge, showing presumable movement of the wall charge of each electrode. FIG. 6A shows the wall charge just after the completion of the major aging discharge following the application of positive voltage to scan electrode 5. Scan electrode 5 carries negative charges, while sustain electrode 6 carries positive charges. A potential drop triggered by ringing—even if the potential drop has not enough magnitude to generate discharge between scan electrode 5 and sustain electrode 6—induces the discharge between scan electrode 5 and data electrode 10, because that the discharge between those electrodes starts at a low voltage. At this time, the discharge occurred between electrodes 5 and 10 serves as a priming discharge, which substantially decrease the voltage level at the start of the discharge between scan electrode 5 and sustain electrode 6, thereby inducing the erase discharge between the scan electrode 5 and sustain electrode 6, as shown in FIG. 6C.

That is, the priming discharge initially occurred between scan electrode 5 and data electrode 10 triggers the erase discharge between scan electrode 5 and sustain electrode 6.

FIG. 6D shows the wall charges after completion of the erase discharge. The erase discharge decreases the amount of the wall charges, so that a large voltage is required to perform the following discharge.

As described above, suppressing the initial discharge between scan electrode 5 and data electrode 10 can also suppress the erase discharge between scan electrode 5 and sustain electrode 6. Taking the fact into consideration, negative voltage is applied to data electrode 10 at the exact moment when negative voltage is applied to scan electrode 5 by ringing, whereby the initial discharge between electrodes 5 and 10 can be suppressed, accordingly, the erase discharge can be suppressed.

In an AC-type PDP, each electrode is isolated from the discharge space, since the electrodes are covered with the dielectric layers. Therefore, a direct voltage component has no contribution to the discharge itself. The application of negative voltage to the data electrode at the moment of the occurrence of the erase discharge has the same effect as the application of positive voltage to the data electrode in a period having no erase discharge. That is, the waveforms of voltage applied to the data electrode of FIGS. 5C and 5D have the same effect.

Third Exemplary Embodiment

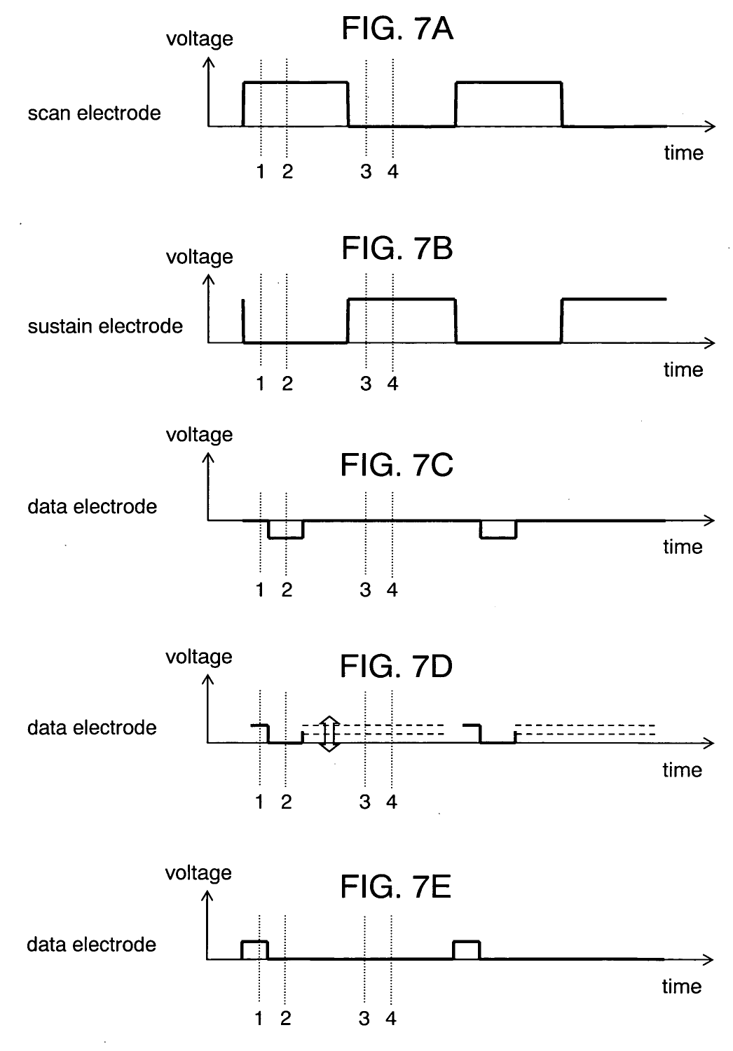

FIG. 7 shows a waveform of voltage applied to an electrode in the aging method of a third embodiment. FIGS. 7A and 7B show the waveforms of voltage applied to scan electrodes 5 and sustain electrodes 6, respectively. The voltage applied to electrodes 5 and 6 is a simple rectangular pulse train having alternate voltage component. FIG. 7C shows the waveform of voltage applied to data electrodes 10. The aging method of the embodiment differs from the method of the second embodiment in that voltage is applied to data electrodes 10 to suppress the erase discharge that occurs in succession to the aging discharge in the wake of increase in voltage applied to scan electrode 5 or decrease in voltage applied to sustain electrode 6. More specifically, the aging method suppresses the erase discharge that occurs when scan electrode 5 takes voltage level higher than sustain electrode 6. Therefore, the successive discharge is intensified; in this case, the successive discharge is the discharge that occurs in the wake of decrease in voltage applied to scan electrode 5 or increase in voltage applied to sustain electrode 6, that is, scan electrode 5 takes the lower voltage-side with respect to sustain electrode 6. In the aging discharge that occurs when scan electrode 5 takes the lower voltage-side, a region on the side of scan electrode 5 of the panel undergoes ion-sputtering caused by positive ions moving toward scan electrode 5 in the discharge space, thereby accelerating the aging. In this way, the application of the voltage waveform shown in FIG. 7C to data electrode 10 accelerates the aging of a region on the side of scan electrode 5 than a region on the side of sustain electrode 6.

In a sequence of initial, writing, and sustaining discharge of the 3-electrode PDP in operation, the writing discharge and the sustaining discharge are under the influence of the operating voltage. Generally in the sustaining discharge, because the rectangular pulse train generates the discharge between scan electrode 5 and sustain electrode 6, the area of each electrode close to discharge gap 20 is subjected to the discharge. As for the writing discharge, the discharge between scan electrodes 5 and data electrodes 10 is the primary discharge. The discharge occurs in almost all over the surface of the regions on the side of scan electrodes 5, which face data electrodes 10. Therefore, accelerating the aging on the side of scan electrodes 5 rather than on the side of sustain electrodes 6 is effective in acquiring stability in the panel operation, compared to the aging equally performed on both sides of scan electrodes 5 and sustain electrodes 6. The inventors experimentally found that the application of voltage having the waveform shown in FIG. 7C to data electrodes 10 accelerated the aging on the side of scan electrodes 5, enhancing aging efficiency.

In this case, the voltage waveforms shown in FIGS. 7D and 7E are also effective, as well as the waveform shown in FIG. 7C. In both the waveforms of FIGS. 7D and 7E, the voltage level of timing 1 is higher than that of timing 2 (where, timing 1 is the moment at which the aging discharge occurs in the wake of increase in voltage applied to scan electrode 5 or decrease in voltage applied to sustain electrode 6, and timing 2 is the moment at which the erase discharge occurs after the aging discharge.)

Hereinafter will be described the reason why these waveforms are as effective as the waveform of FIG. 7C. After a strong discharge, such as the aging discharge occurred at timing 1, rearrangement of the wall charges takes place so as to ease the intensity of the electric field in the discharge cell. The rearranged wall charges, to which the potential drop by ringing is added, generate the successive erase discharge at timing 2. Therefore, the erase discharge is effectively suppressed by applying the voltage equivalent to the amount of change in voltage from the moment when the aging discharge occurs (at timing 1). In other words, if timing 1 and timing 2 have the same voltage, there is no suppressing effect on the erase discharge. The method of the embodiment focuses on the erase discharge at timing 2, not on the erase discharge at timing 4 where scan electrode 5 keeps a voltage lower than sustain electrode 6. Therefore, as long as the voltage level is the same at timing 3 and timing 4 as shown in FIG. 7D, the voltage is not limited to a specific value. That is, the voltage waveform of FIG. 7E has the same effect as those shown FIGS. 7C and 7D.

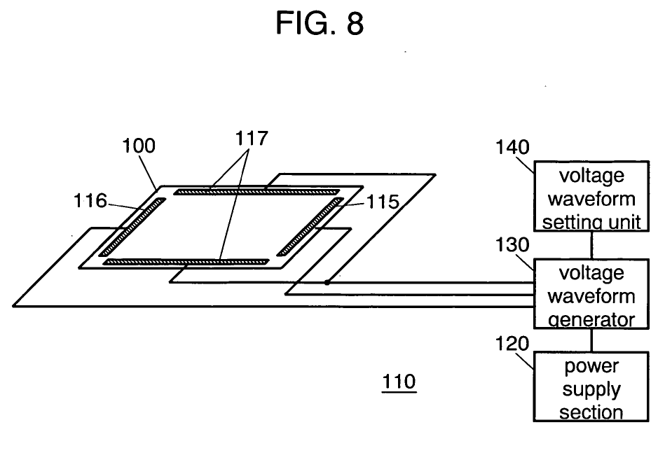

FIG. 8 is a block diagram illustrating the structure of an aging device according to the aging methods of the first through the third embodiments of the present invention. Aging device 110 has power supply section 120 for feeding electric power, voltage waveform generator 130 for generating a waveform of voltage to be applied to each electrode, voltage waveform setting unit 140 for defining a voltage waveform for each electrode, and panel table (not shown) for mounting panel 100 to be performed aging. A plurality of scan electrode terminal sections 15₁-15ₙ disposed on panel 100, which is short-circuited by short-circuit bar 115, is connected to the scan electrode output section of voltage waveform generator 130 via cables. Similarly, sustain electrode terminal sections 16₁-16ₙ and data electrode terminal sections ¹⁷₁-17ₙ, which are short-circuited by short-circuit bars 116 and 117, respectively, are connected to voltage waveform generator 130. Voltage waveform generator 130 generates and supplies a voltage waveform suitable for scan electrode 5, sustain electrode 6, and data electrode 10 of panel 100, as is described in the first through the third embodiments, thereby performing the aging process. Voltage waveform setting unit 140 determines the optimal setting values, such as the pulse-repetition frequency, the timing and value of the application of voltage, according to panel 100 to be processed.

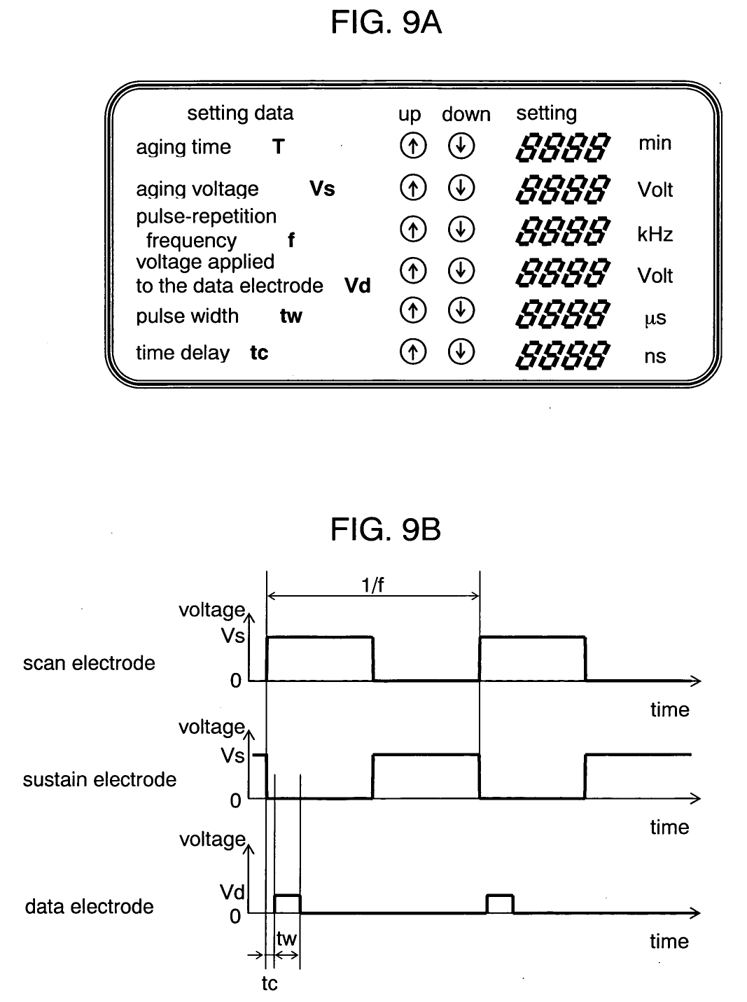

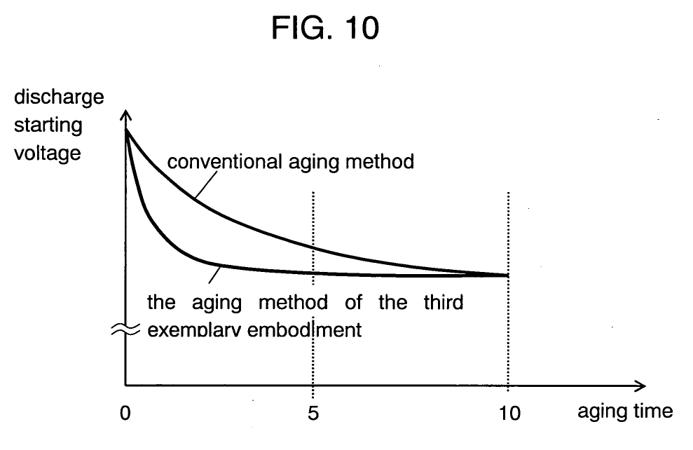

FIG. 9A shows an appearance of voltage waveform setting unit 140 of the aforementioned aging device. FIG. 9B illustrates the setting values to be defined in setting unit 140 by showing a waveform of voltage applied to each electrode according to the third embodiment. In voltage waveform setting unit 140 shown in FIG. 9, aging time (T), alternative waveform voltage value to be applied to the scan electrode and sustain electrode (Vs), pulse-repetition frequency (f), pulse waveform voltage value to be applied to the data electrode (Vd), pulse width (tw), pulse-repetition period (tc) can be individually defined. Although no particular description is given to the pulse-repetition period, the setting of the pulse-repetition period should preferably be adjustable. It is useful not only for performing the aging process on various kinds of panel 100, but also for adapting manufacturing environment, such as controlling inductance of the aging circuit that depends on the length of wiring of a pallet used for conveying the panels.

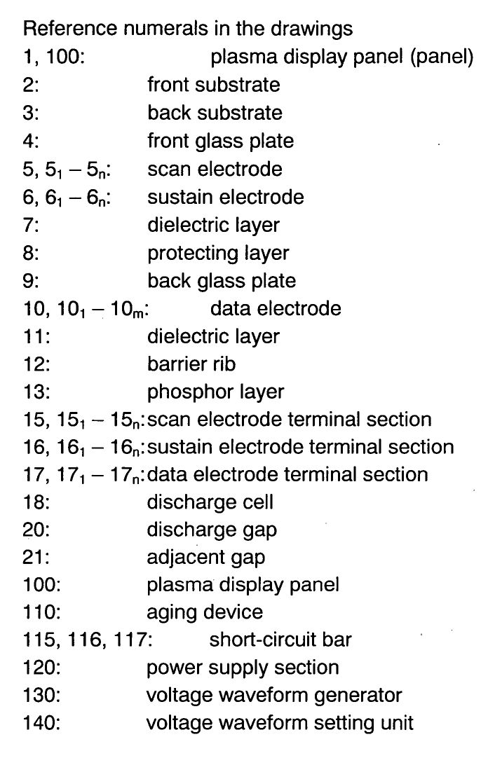

FIG. 10 shows the aging time shortened by the aging method of the third embodiment in comparison with the time required in a conventional aging method. In the graph of FIG. 10, the horizontal axis represents the aging time, and the vertical axis represents the voltage at the start of discharge between the scan electrodes and the sustain electrodes. The aging process is completed when the discharge starting voltage decreases to a predetermined value. In a conventional aging method, it took about 10 hours for the aging process due to the slow decrease in the voltage. In contrast, according to the aging method of the third embodiment, the discharge starting voltage decreases with a steep curve to have stability, achieving about one-third the time of the conventional aging.

As described above, the aging method of the present invention realizes an electrically efficient aging process with greatly reduced aging time.

### INDUSTRIAL APPLICABILITY

The method of aging plasma display panel of the present invention can provide an electrically efficient aging with substantial reductions in time required to the aging process. It is therefore useful for aging AC plasma display panels in the manufacturing process.

1. A method of aging a plasma display panel containing a scan electrode, a sustain electrode, and a data electrode, the method having an aging process for performing an aging discharge by application of voltage having an alternate voltage component to at least between the scan electrode and the sustain electrode, wherein a voltage for suppressing an erase discharge that occurs in the wake of the aging discharge is applied to at least any one of the scan electrode, the sustain electrode, and the data electrode.

2. The method of aging the plasma display panel of claim 1, wherein the erase discharge-suppressing voltage is applied to the data electrode.

3. The method of aging the plasma display panel of claim 1, wherein the erase discharge-suppressing voltage suppresses occurrence of the erase discharge after the aging discharge takes place due to any one of increase in voltage applied to the scan electrode or decrease in voltage applied to the sustain electrode.

4. The method of aging the plasma display panel of claim 1, wherein the application of the erase discharge-suppressing voltage is provided to the data electrode, and an aging-discharge generating moment—at which the aging discharge takes place in the wake of any one of increase in voltage applied to the scan electrode or decrease in voltage applied to the sustain electrode—carries higher voltage than an erase-discharge generating moment at which the erase discharge takes place after the aging discharge.

5. The method of aging the plasma display panel of claim 2, wherein the erase discharge-suppressing voltage suppresses occurrence of the erase discharge after the aging discharge takes place due to any one of increase in voltage applied to the scan electrode or decrease in voltage applied to the sustain electrode.
